(19) United States
(12) Patent Application Publication
(10) Pub. No.: US 2013/0131209 A1
(43) Pub. Date: May 23, 2013

(54) Polyglycolic Acid Particle, Production Process of Polyglycolic Acid Particle, and Use Thereof

(71) Applicants: Kazuyuki Yamane, Tokyo (JP); Kensuke Suzuki, Tokyo (JP)

(72) Inventors: Kazuyuki Yamane, Tokyo (JP); Kensuke Suzuki, Tokyo (JP)

(73) Assignee: Kureha Corporation, Tokyo (JP)

(21) Appl. No.: 13/813,893

(22) PCT Filed: Jul. 21, 2011
(86) PCT No.: PCT/JP2011/066581

§ 371 Date: Feb. 1, 2013

(30) Foreign Application Priority Data
Aug. 3, 2010 (JP) 2010-174834

(51) Int. Cl. C08G 63/06

(52) U.S. Cl. CPC C08G 63/06
USPC 521/182; 528/361; 524/599; 428/402

(57) ABSTRACT

Polyglycolic acid particles comprising polyglycolic acid having (a) at least 70% by mol of a glycolic acid repeating unit, (b) Mw of 30,000 to 800,000, (c) Mw/Mn of 1.5 to 4.0, (d) a melting point of 197 to 245° C. and (e) a melt crystallization temperature T_{C2} of 130 to 195° C., and having (i) an average particle diameter (D₅₀) of 3 to 50 μm, and preferably having (ii) D₉₀/D₁₀ of 1.1 to 12, a production process of the particles, including a solution-forming step of dissolving polyglycolic acid in an aprotic polar organic solvent at 150 to 240° C.; a cooling step of cooling the solution to 140° C. or lower at a rate less than 20° C./min to obtain a suspension of polyglycolic acid particles; and a separation step, and a slurry, (powder) coating or toner containing the particles.

### TECHNICAL FIELD

The present invention relates to high-molecular weight polyglycolic acid particles having a particle diameter within a particular range, scarcely containing fine particles and preferably having a narrow particle diameter distribution and excellent handling property, a production process of the polyglycolic acid particles, and uses thereof.

The present invention also relates to uses of polyglycolic acid particles as environmentally benign coatings, toners for electrostatic copying machines, etc., wherein the particles are used as they are or in the form of a slurry containing the particles, polyglycolic acid particles useful for these uses, and an efficient production process thereof.

### BACKGROUND ART

Aliphatic polyesters such as polylactic acid and polyglycolic acid attract attention as biodegradable polymeric materials which impose little burden on an environment because they are degraded by microorganisms or enzymes present in the natural world such as soil and sea. The aliphatic polyesters are also utilized as medical polymeric materials for surgical sutures, artificial skins, etc. because they have degradability and absorbability in vivo.

An aliphatic polyester can be synthesized by, for example, dehydration polycondensation of an α-hydroxycarboxylic acid such as glycolic acid or lactic acid. In order to efficiently synthesize a high-molecular weight aliphatic polyester, however, a process of synthesizing a bimolecular cyclic ester of the α-hydroxycarboxylic acid and subjecting the cyclic ester to ring-opening polymerization is generally adopted. For example, when glycolide that is a bimolecular cyclic ester of glycolic acid is subjected to ring-opening polymerization, polyglycolic acid is obtained. When lactide that is a bimolecular cyclic ester of lactic acid is subjected to ring-opening polymerization, polylactic acid is obtained.

Among the aliphatic polyesters, the polyglycolic acid (hereinafter may be referred to as “PGA”) is also excellent in heat resistance, mechanical strength such as tensile strength and, in particular, gas barrier properties when provided as a film or sheet in addition to high degradability. Therefore, PGA is expected to be utilized as agricultural materials, various kinds of packaging (container) materials and medical polymeric materials, and development of applications thereof is attempted by itself or as a composite with another resin material or the like. As production methods of these products, are adopted melt molding or forming and other molding or forming methods, such as extrusion, injection molding, compression molding, injection compression molding, transfer molding, cast molding, stampable molding, blow molding, stretch blow molding, blown-film extrusion, lamination molding, calendering, foam extrusion and expansion molding, reaction injection molding (RIM), FRP molding or forming, and powder or paste molding.

On the other hand, attention is attracted to degradability, strength, etc. of PGA, and PGA particles useful as a raw material, an additive or the like in fields such as coatings, coating materials, inks, toners, agricultural chemicals, medicines, cosmetics, mining and oil drilling are desired. As PGA particles applied to these fields, are required those having excellent handling property, a moderate particle diameter and uniform shape and particle diameter distribution. For example, if the particle diameter is too small, handling property of such particles becomes poor, and the surface area thereof becomes large, so that influence of a degradation speed becomes great, and it is also considered that the excellent properties of the PGA as described above are lowered. Accordingly, high-molecular weight PGA particles having a particle diameter of about 3 to 50 μm have been required.

Resin particles having biodegradability, not limited to PGA, are expected to be usefully used in, for example, a field in which the particles are used in a natural environment, a field in which recovery and re-use after use are difficult, and a field in which a particular function of a resin is utilized, so that various production processes have been proposed.

As production processes of resin particles, are generally known a production process of particles by cutting or grinding of a solidified product of a melt and a production process of particles by deposition from a solution or dispersion. Japanese Patent Application Laid-Open No. 2001-288273 (Patent Literature 1) discloses a production process of powder of a polylactic acid resin, comprising refrigerating chips or massive lumps of the polylactic acid resin to a low temperature of from −50 to −180° C., and grinding and classifying them. Japanese Patent Application Laid-Open No. 11-35693 (Patent Literature 2) discloses a production process of a powdered polyester having biodegradability, comprising mixing an organic solvent solution of a polyester having biodegradability with an aromatic hydrocarbon having a substituent group at a temperature lower than 60° C. and subjecting a solid material deposited to solid-liquid separation. In Examples thereof, polylactic acid having a weight average molecular weight (Mw) of 145,000, polybutylene succinate having an Mw of 100,000 and a polylactic acid-polybutylene succinate copolymer having an Mw of 172,000 are respectively used as a raw material.

On the other hand, as a production process of porous or microporous resin powder, Japanese Patent Application Laid-Open No. 58-206637 (Patent Literature 3; corresponding to U.S. Pat. No. 4,471,077) and Japanese Patent Application Laid-Open No. 61-42531 (Patent Literature 4; corresponding to U.S. Pat. No. 4,645,664) discloses a production process of powdered polylactide, comprising heating and dissolving polylactide in xylene or diethyl phthalate, cooling a clear and bright solution produced, and removing the solvent.

However, a process for simply producing a particulate PGA for making better use of the properties of the PGA, i.e., PGA particles having excellent handling property, moderate particle diameter and shape, and preferably a moderate particle diameter distribution is not known. Accordingly, PGA particles having such properties are not provided.

When the PGA particles are produced by, for example, grinding, extremely fine particles are contained to no small extent, and further particles having a broad particle size distribution are obtained, and so there has been a problem that hygroscopicity is increased because of irregularity of a ground surface or cut surface. In addition, in the production process of the particles for which a large amount of the organic solvent is required, there is a fear that the organic solvent may remain in the polymer.

In addition, there is a melt-granulating process by melting and stiffing PGA together with an organic solvent under heat for obtaining PGA particles while causing depolymerization to proceed. However, the molecular weight of the PGA has been greatly lowered to obtain only particles having a broad particle diameter distribution. That is, high-molecular weight PGA particles having a weight average molecular weight (Mw) of 30,000 or higher are desired for making good use of strength properties of the PGA.

Japanese Patent Application Laid-Open No. 2006-45542 (Patent Literature 5) discloses a production process of a coating for coating a metal-made can lid, comprising (a) a step of dissolving a thermoplastic resin in an organic solvent to obtain a solution, (b) a step of cooling the solution to obtain a suspension of particles of the thermoplastic resin having an average primary particle diameter of 10 to 1,000 nm, (c) a step of separating the particles from the suspension, and (d) a step of dispersing the particles separated in a solvent, and as examples of the thermoplastic resin, are mentioned aromatic polyester resins and aliphatic polyester resins. Patent Literature 5 discloses that the temperature of the solvent dissolving the thermoplastic resin is preferably 70 to 200° C., and in case where the thermoplastic resin is PGA, the temperature of the solvent is preferably 130 to 170° C., more preferably 140 to 160° C., and describes that the solution of the thermoplastic resin is cooled to 50° C. or lower, preferably 45° C. or lower, and a cooling rate is preferably 20° C./s or higher, more preferably 50° C./s or higher, still more preferably 100° C./s or higher.

Patent Literature 5 describes, as Preparation Example 4, that a suspension of particles having an average primary particle diameter of 150 nm or smaller was obtained by using PGA and bis(2-methoxyethyl)ether as a solvent, and controlling a dissolution temperature and a cooling temperature to 150° C. and −35° C., respectively.

### CITATION LIST

### Patent Literature

Patent Literature 1: Japanese Patent Application Laid-Open No. 2001-288273
Patent Literature 2: Japanese Patent Application Laid-Open No. 11-35693
Patent Literature 3: Japanese Patent Application Laid-Open No. 58-206637
Patent Literature 4: Japanese Patent Application Laid-Open No. 61-42531
Patent Literature 5 Japanese Patent Application Laid-Open No. 2006-45542

### SUMMARY OF INVENTION

### Technical Problem

It is an object of the present invention to provide high-molecular weight polyglycolic acid particles having a particular particle diameter, scarcely containing fine particles and preferably having a narrow particle diameter distribution and excellent handling property, an efficient production process of the polyglycolic acid particles, and uses thereof.

### Solution to Problem

The present inventors have paid attention to the process disclosed in Patent Literature 5 in which the PAS particles are obtained by the simple process comprising dissolution in the organic solvent and cooling and have carried out extensive researches repeatedly. As a result, the inventors have reached PGA particles which comprise high-molecular weight PGA, and are controlled to a desired particle diameter, more preferably, narrow in particle diameter distribution, little in fine particles and excellent in handling property, and a process for producing the PGA particles.

According to the present invention, there is thus provided PGA particles comprising PGA having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and

having (i) an average particle diameter of 3 to 50 μm as represented by a 50% cumulative value (D₅₀) in a number particle diameter distribution.

According to the present invention, there are provided the following embodiments as to the PGA particles.

(1) The PGA particles, wherein (ii) a ratio of a 90% cumulative value (D₉₀) in the number particle diameter distribution to a 10% cumulative value (D₁₀) in the number particle diameter distribution is 1.1 to 12.
(2) The PGA particles described above, wherein the PGA is PGA obtained by subjecting 70 to 100% by mass of glycolide and 30 to 0% by mass of another cyclic monomer to ring-opening polymerization.
(3) The PGA particles described above, wherein the PGA particles are porous PGA particles having voids of at least 30%.

According to the present invention, there is also provided a production process of PGA particles, comprising the following steps (I) to (III):

Step (I): a solution-forming step of dissolving PGA in an aprotic polar organic solvent at a temperature of 150 to 240° C.;
Step (II): a cooling step of cooling the solution to 140° C. or lower at a rate less than 20° C./min with stirring to obtain a suspension containing PGA particles; and
Step (III): a separation step of separating the particles from the suspension,
wherein the PGA particles comprise PGA having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and have (i) an average particle diameter of 3 to 50 μm as represented by a 50% cumulative value (D₅₀) in a number particle diameter distribution.

According to the present invention, there are provided the following embodiments as to the production process of the PGA particles.

(4) The above-described production process of the PGA particles, wherein the polyglycolic acid particles have (ii) a ratio of a 90% cumulative value (D₉₀) in the number particle diameter distribution to a 10% cumulative value (D₁₀) in the number particle diameter distribution of 1.1 to 12.
(5) The above-described production process of the PGA particles, wherein the PGA is PGA obtained by subjecting 70 to 100% by mass of glycolide and 30 to 0% by mass of another cyclic monomer to ring-opening polymerization.
(6) The above-described production process of the PGA particles, wherein the PGA particles are porous PGA particles having voids of at least 30%.
(7) The above-described production process of the PGA particles, wherein in Step (I), 1 to 30 parts by mass of the PGA is dissolved in 100 parts by mass of the aprotic polar organic solvent.

According to the present invention, there are further provided a slurry containing these PGA particles, a coating containing these PGA particles, in particular, a powder coating containing these PGA particles, and a toner containing these PGA particles.

### Advantageous Effects of Invention

Since the present invention provides the high-molecular weight PGA particles having a particular particle diameter, a narrow particle diameter distribution and excellent handling property, the present invention exhibits effects that there can be provided PGA particles useful as a raw material, an additive or the like in fields such as coatings, coating materials, inks, toners, agricultural chemicals, medicines, cosmetics, mining and oil drilling making good use of the properties of the PGA, such as degradability and strength, and the PGA particles can be efficiently provided. As a result, the present invention exhibits an effect that the PGA particles can be applied to uses making good use of the properties thereof.

### DESCRIPTION OF EMBODIMENTS

The PGA particles according to the present invention are PGA particles comprising PGA having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and having (i) an average particle diameter of 3 to 50 μm as represented by a 50% cumulative value (D₅₀) in a number particle diameter distribution.

The production process of the PGA particles according to the present invention is a production process of PGA particles, comprising the following steps (I) to (III):

Step (I): a solution-forming step of dissolving PGA in an aprotic polar organic solvent at a temperature of 150 to 240° C.;
Step (II): a cooling step of cooling the solution to 140° C. or lower at a rate less than 20° C./min with stirring to obtain a suspension containing PGA particles; and
Step (III): a separation step of separating the particles from the suspension,
wherein the PGA particles comprise PGA having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and
have (i) an average particle diameter of 3 to 50 μm as represented by a 50% cumulative value (D₅₀) in a number particle diameter distribution.

### 1. Polyglycolic Acid

The PGA according to the present invention includes not only a homopolymer (including a ring-opening polymer of glycolide (GL) that is a bimolecular cyclic ester of glycolic acid) of glycolic acid, which is composed of only a glycolic acid repeating unit represented by —(O.CH₂.CO)—, but also a PGA copolymer containing at least 70% by mol of the glycolic acid repeating unit. That is, the PGA according to the present invention contains the glycolic acid repeating unit in a proportion of at least 70% by mol, preferably at least 80% by mol, more preferably at least 90% by mol, still more preferably at least 95% by mol, particularly preferably at least 98% by mol, most preferably at least 99% by mol providing PGA that is substantially a homopolymer. If this proportion is too low, strength and degradability expected of the PGA become poor. Other repeating units than the glycolic acid repeating unit are used in a proportion of at most 30% by mol, preferably at most 20% by mol, more preferably at most 10% by mol, still more preferably at most 5% by mol, particularly preferably at most 2% by mol, most preferably at most 1% by mol.

As examples of a comonomer for providing a PGA copolymer together with a glycolic acid monomer such as the glycolide, may be mentioned cyclic monomers such as ethylene oxalate (i.e., 1,4-dioxane-2,3-dione), lactides, lactones, carbonates, ethers, ether esters and amides; hydroxycarboxylic acid such as lactic acid, 3-hydroxypropanoic acid, 3-hydroxybutanoic acid, 4-hydroxybutanoic acid and 6-hydroxycaproic acid, and alkyl ester thereof; substantially equimolar mixtures of an aliphatic diol such as ethylene glycol or 1,4-butanediol and an aliphatic carboxylic acid such as succinic acid or adipic acid or an alkyl ester thereof; and mixtures of two or more monomers thereof. These comonomers may also be used in the form of polymers thereof as starting materials for providing the PGA copolymer together with the glycolic acid monomer such as the glycolide.

The content of the glycolic acid repeating unit in the PGA according to the present invention is at least 70% by mol. If this proportion is too low, strength and degradability expected of the PGA become poor.

As the PGA according to the present invention, is preferred PGA obtained by polymerizing 70 to 100% by mass of glycolide and 30 to 0% by mass of said another comonomer for efficiently producing a desired high-molecular weight polymer. Another comonomer may be either a bimolecular cyclic monomer or a mixture of both monomers, not the cyclic monomer. However, the cyclic monomer is preferred for providing the PGA particles intended by the present invention. PGA obtained by subjecting 70 to 100% by mass of glycolide and 30 to 0% by mass of another comonomer to ring-opening polymerization will hereinafter be described in detail.

### [Glycolide]

Glycolide for forming PGA by ring-opening polymerization is a bimolecular cyclic ester of glycolic acid that is a hydroxycarboxylic acid. No particular limitation is imposed on the production process of the glycolide. However, the glycolide can be generally obtained by depolymerizing a glycolic acid oligomer under heat. As a method for the depolymerization of the glycolic acid oligomer, may be adopted, for example, a melt depolymerization method, a solid-phase depolymerization method or a solution-phase depolymerization method. Glycolide obtained as a cyclic condensate of a chloroacetic acid salt may also be used. Incidentally, that containing glycolic acid in an amount up to 20% by mass of the glycolide may be used as the glycolide if desired.

The PGA according to the present invention may be formed by subjecting the glycolide alone to ring-opening polymerization. However, a copolymer may also be formed by subjecting another cyclic monomer as a copolymerization component to the ring-opening polymerization at the same time. When the copolymer is formed, the proportion of the glycolide is at least 70% by mass, preferably at least 80% by mass, more preferably at least 90% by mass, still more preferably at least 95% by mass, particularly preferably at least 98% by mass, most preferably at least 99% by mass providing PGA that is substantially a homopolymer.

### [Cyclic Monomer]

As another cyclic monomer usable as the copolymerization component with the glycolide, any of cyclic monomers such as lactones (for example, β-propiolactone, β-butyrolactone, pivalolactone, γ-butyrolactone, δ-valero lactone, β-methyl-δ-valerolactone, ε-caprolactone, etc.), trimethylene carbonate and 1,3-dioxane may be used in addition to bimolecular cyclic esters of other hydroxycarboxylic acids, such as lactide. Preferable another monomer is a bimolecular cyclic ester of another hydroxycarboxylic acid, and as examples of the hydroxycarboxylic acid, may be mentioned L-lactic acid, D-lactic acid, α-hydroxybutyric acid, α-hydroxyisobutyric acid, α-hydroxyvaleric acid, α-hydroxy-caproic acid, α-hydroxyisocaproic acid, α-hydroxyheptanoic acid, α-hydroxyoctanoic acid, α-hydroxydecanoic acid, α-hydroxymyristic acid, α-hydroxystearic acid and alkyl-substituted products thereof. A particularly preferable another cyclic monomer is lactide that is a bimolecular cyclic ester of lactic acid, and the lactide may be any of an L-form, a D-form, a racemic modification and mixtures thereof.

Another cyclic monomer is used in a proportion of at most 30% by mass, preferably at most 20% by mass, more preferably at most 10% by mass, still more preferably at most 5% by mass, particularly preferably at most 2% by mass, most preferably at most 1% by mass. The glycolide and another cyclic monomer are subjected to ring-opening polymerization, whereby the melting point of the resulting PGA (copolymer) can be lowered to lower the processing temperature thereof, and the crystallization speed of the PGA can be controlled to improve the extrusion processability and stretch processability thereof. However, if the proportion of these cyclic monomers is too high, the crystallinity of PGA (copolymer) formed is impaired, and its heat resistance, gas barrier properties, mechanical strength, etc. are deteriorated. Incidentally, when the PGA is formed from 100% by mass of glycolide, the proportion of another cyclic monomer is 0% by mass, and this PGA is also included in the scope of the present invention.

### [Ring-Opening Polymerization Reaction]

The ring-opening polymerization or ring-opening copolymerization (hereinafter may be referred to as “ring-opening (co)polymerization” generally) of glycolide is preferably conducted in the presence of a small amount of a catalyst. No particular limitation is imposed on the catalyst. However, examples thereof include tin compounds such as tin halides (for example, tin dichloride, tin tetrachloride, etc.) and organic tin carboxylates (for example, tin octanoates such as tin 2-ethylhexanoate); titanium compounds such as alkoxytitanates; aluminum compounds such as alkoxyaluminum; zirconium compounds such as zirconium acetylacetone; and antimony compounds such as antimony halides and antimony oxide. The amount of the catalyst used is preferably about 1 to 1,000 ppm, more preferably about 3 to 300 ppm in terms of a mass ratio to the cyclic ester.

Glycolide generally contains, as impurities, a trace amount of water and hydroxycarboxylic acid compounds including glycolic acid and linear glycolic acid oligomers. The overall proton concentration of these impurities are controlled to preferably 0.01 to 0.5% by mol, more preferably 0.02 to 0.4% by mol, particularly preferably 0.03 to 0.35% by mol, whereby physical properties of PGA formed, such as melt viscosity and molecular weight can be controlled. The control of the overall proton concentration may also be performed by adding water to purified glycolide.

The ring-opening (co)polymerization of the glycolide may be conducted by either bulk polymerization or solution polymerization. In many cases, however, the bulk polymerization is adopted. A higher alcohol such as lauryl alcohol, water or the like may be used as a molecular weight modifier for the purpose of regulating the molecular weight of the resulting polymer. In addition, a polyhydric alcohol such as glycerol may be added for the purpose of improving the physical properties of the resulting polymer. A polymerizer for the bulk polymerization may be suitably selected from among various kinds of apparatus such as extruder type, vertical type having a paddle blade, vertical type having a helical ribbon blade, horizontal type such as an extruder type or kneader type, ampoule type, plate type and annular type. Various kinds of reaction vessels may be used for the solution polymerization.

The polymerization temperature can be suitably preset within a range of from 120° C., which is a substantial polymerization-initiating temperature, to 300° C. as necessary for the end application intended. The polymerization temperature is preferably 130 to 270° C., more preferably 140 to 260° C., particularly preferably 150 to 250° C. If the polymerization temperature is too low, PGA formed tends to have a broad molecular weight distribution. If the polymerization temperature is too high, PGA formed tends to undergo thermal decomposition. The polymerization time is within a range of from 3 minutes to 20 hours, preferably from 5 minutes to 18 hours. If the polymerization time is too short, it is hard to sufficiently advance the polymerization, so that a predetermined weight average molecular weight cannot be realized. If the polymerization time is too long, PGA formed tends to be colored.

After the PGA formed is made a solid state, solid-phase polymerization may be additionally conducted if desired. The solid-phase polymerization means a process that a heat treatment is conducted while retaining the solid state by heating the PGA at a temperature lower than the melting point of the PGA. By this solid-phase polymerization, low-molecular weight components such as an unreacted monomer and oligomers are volatilized off. The solid-phase polymerization is conducted for, preferably 1 to 100 hours, more preferably 2 to 50 hours, particularly preferably 3 to 30 hours.

Thermal history may be applied to the PGA in the solid state by a step of melting and kneading the PGA at a temperature higher by at least 38° C. than the melting point Tm of the PGA, preferably in a temperature range of from Tm +38° C. to Tm +100° C., thereby controlling the crystallinity thereof.

### [Weight Average Molecular Weight (Mw)]

The PGA obtained by any of these polymerization processes is used as a raw material to produce high-molecular weight PGA particles having a narrow particle diameter distribution. Since lowering of the molecular weight cannot be avoided in the course of the production of the PGA particles, the weight average molecular weight (Mw) of the PGA obtained by the polymerization, which becomes a raw material of the PGA particles according to the present invention, is preferably within a range of 100,000 to 1,500,000, and PGA having a molecular weight within a range of more preferably 120,000 to 1,300,000, still more preferably 150,000 to 1,100,000, particularly preferably 180,000 to 1,000,000 is selected.

### [Terminal Carboxyl Group Concentration]

The terminal carboxyl group concentration of the PGA which becomes a raw material of the PGA particles is controlled to preferably 0.1 to 300 eq/10⁶ g, more preferably 1 to 250 eq/10⁶ g, still more preferably 6 to 200 eq/10⁶ g, particularly preferably 12 to 75 eq/10⁶ g, whereby the degradability of the resulting PGA particles can be adjusted to an optimum degree. Carboxyl groups and hydroxyl groups are present in the molecule of the PGA. If the concentration of a carboxyl group located at an end of the molecule among these, i.e., a terminal carboxyl group concentration, is too low, the hydrolyzability of such a polymer becomes too low, so that the degradation rate thereof is lowered. If the terminal carboxyl group concentration is too high, hydrolysis is caused to rapidly proceed, so that the resulting PGA particles cannot exhibits coating film strength and toner performance over a long period of time. In addition, the initial strength of such a PGA is low, so that lowering of the strength is accelerated. In order to control the terminal carboxyl group concentration, it is only necessary to change, for example, the kind of the catalyst or molecular weight modifier upon the polymerization of the PGA.

### [Residual Glycolide]

The amount of glycolide remaining in the PGA which becomes a raw material of the PGA particles is controlled to preferably at most 0.2% by mass, more preferably at most 0.15% by mass, particularly preferably at most 0.12% by mass, whereby the molecular weight of the PGA can be inhibited from being lowered during a processing for forming toner particles or a coating film from the resulting PGA particles, so that water resistance can be improved. For this purpose, for example, the polymerization temperature at a final stage (preferably, at the time the reaction rate of the monomer has reached at least 50%) upon the polymerization of the PGA is preferably controlled to lower than 200° C., more preferably 140 to 195° C., still more preferably 160 to 190° C. in such a manner that the system becomes a solid phase. It is also preferable to subject the PGA formed to a step of eliminating and removing the residual glycolide into a gas phase. If the amount of the residual glycolide is too large, the molecular weight of the PGA is lowered during the processing for forming toner particles or a coating film, so that the performance of the resulting PGA particles cannot be exhibited over a long period of time.

### [1%-Weight Loss-Starting Temperature on Heating]

The 1%-weight loss-starting temperature on heating of the PGA which becomes a raw material of the PGA particles is controlled to preferably at least 210° C., more preferably at least 213° C., particularly preferably at least 215° C., whereby the molecular weight of the PGA can be inhibited from being lowered during the processing for forming toner particles or a coating film from the resulting PGA particles. The upper limit of the 1%-weight loss-starting temperature on heating is generally 235° C., preferably 230° C. The 1%-weight loss-starting temperature on heating is used as an index to the heat resistance of the PGA and means a temperature that when the PGA is heated at a heating rate of 2° C./min from 50° C. under a nitrogen stream at a flow rate of 10 ml/min, a weight loss rate from the weight (initial weight) of the PGA at 50° C. reaches 1%. If the 1%-weight loss-starting temperature on heating of the PGA contained in the PGA particles is too low, the molecular weight of the PGA is lowered during the processing for forming toner particles or a coating film, so that the performance of the PGA particles cannot be exhibited over a long period of time. In order to control the 1%-weight loss-starting temperature on heating to at least 210° C., it is only necessary to reduce the amounts of additives such as a catalyst deactivator, a nucleating agent, a plasticizer and an antioxidant added upon the production of the PGA as much as possible.

As raw materials for producing the PGA particles according to the present invention, as needed, other resins, such as aliphatic polyesters such as polylactic acid, polybutylene succinate, polyethylene succinate, poly-β-propiolactone and polycaprolactone, polyglycols such as polyethylene glycol and polypropylene glycol, modified polyvinyl alcohol, polyurethane, and polyamides such as poly-L-lysine, and additives generally incorporated, such as a plasticizer, an antioxidant, a heat stabilizer, an ultraviolet absorber, a lubricant, a parting agent, a wax, a colorant, a crystallization accelerator, a hydrogen ion concentration adjustor and a filler such as reinforcing fiber may be incorporated in addition to the PGA within limits not impeding the object of the present invention.

### 2. PGA Particles Comprising Polyglycolic Acid

The PGA particles according to the present invention are PGA particles obtained from the PGA described in the above item 1, and specifically PGA particles produced through the following steps (I) to (III).

The PGA particles according to the present invention are PGA particles comprising PGA having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C.

### [Weight Average Molecular Weight (Mw)]

The PGA particles according to the present invention are such that the weight average molecular weight (Mw) of the PGA is within a range of 30,000 to 800,000. The weight average molecular weight (Mw) falls within the range of 30,000 to 800,000, whereby the processability, film-forming performance and mechanical strength of the resulting PGA particles are improved. In addition, the weight average molecular weight (Mw) is regulated, whereby the degradation speed of the PGA particles can be controlled. When the weight average molecular weight (Mw) falls within a range of preferably 40,000 to 600,000, more preferably 50,000 to 500,000, still more preferably 53,000 to 450,000, often 55,000 to 400,000, good physical properties can be achieved. If the weight average molecular weight is too low, strength become insufficient. If the weight average molecular weight is too high, it is difficult to process the resulting PGA particles and form a coating film from them.

It is better to select a more preferable weight average molecular weight (Mw) of the PGA according to uses. For example, a range of 100,000 to 400,000 is most preferable when the PGA particles are used in a coating, a range of 80,000 to 300,000 is most preferable when used in a toner, and a range of 70,000 to 350,000 is most preferable when used in oil drilling.

### [Molecular Weight Distribution (Mw/Mn)]

In the PGA particles according to the present invention, the molecular weight distribution of the PGA as represented by a ratio (Mw/Mn) of the weight average molecular weight (Mw) to the number average molecular weight (Mn) is controlled within a range of 1.5 to 4.0, whereby the amount of a polymer component (low-molecular weight polymer) within a low molecular weight region, which is liable to undergo premature biodegradation, can be reduced to control a degradation speed. If the molecular weight distribution is too broad, the biodegradation speed tends not to depend on the weight average molecular weight of the PGA. If the molecular weight distribution is too narrow, it is difficult to retain performance such as film strength and toner strength over a long period of time. The weight average molecular weight distribution is preferably 1.6 to 3.7, more preferably 1.7 to 3.5.

The weight average molecular weight and molecular weight distribution of the PGA contained in the PGA particles are controlled within the above-described respective ranges, whereby the particle diameter and particle size distribution of the particles can be controlled, and the degradation performance and the like thereof can also be controlled.

In order to control the weight average molecular weight (Mw) and molecular weight distribution (Mw/Mm) of the PGA contained in the PGA particles within the predetermined respective ranges, it is only necessary to devise, for example, the kind and amount of the polymerization catalyst, the kind and amount of the molecular weight modifier, polymerization conditions such as a polymerization device, polymerization temperature and polymerization time, a post-treatment after polymerization and mixtures thereof upon the polymerization of the PGA.

For example, when the polymerization temperature upon the polymerization of the PGA is low, a polymer formed is liable to be crystallized during the polymerization reaction, and the polymerization reaction tends to become uneven. As a result, the molecular weight distribution of the PGA tends to become broad, and so the molecular weight distribution of the resulting PGA particles becomes broad. When the polymerization temperature is high, a polymer formed is liable to undergo thermal decomposition. In addition, when polymerization conditions of relatively high polymerization temperature and relatively short polymerization time are adopted, the molecular weight distribution of a polymer formed tends to become sharp. When the temperature of the polymerization reaction system is raised to 220 to 250° C. after completion of the polymerization reaction, or the formed polymer is melted and kneaded, the amount of the low-molecular weight component is reduced, and the molecular weight distribution tends to become sharp.

### [Melting Point (Tm)]

The melting point of the PGA contained in the PGA particles is 197 to 245° C. and can be controlled by the kind and proportion of a copolymerization component contained. The melting point is preferably 200 to 240° C., more preferably 205 to 235° C., particularly preferably 210 to 230° C. The melting point of the PGA in the form of a homopolymer is generally about 220° C. If the melting point is too low, strength in case where the resulting PGA particles are used as a toner or coating becomes insufficient, and temperature control in case where processing is conducted becomes difficult. If the melting point is too high, in some cases, the processability of the resulting PGA particles may become insufficient, or the flexibility of a coating film formed may become insufficient. If the melting point is too high, it is impossible to sufficiently control the dissolution of such a PGA in the aprotic polar organic solvent in the solution-forming step and the formation of the particles in the cooling step, so that the particle diameter and particle size distribution of the resulting PGA particles do not fall within the desired respective ranges.

### [Melt Crystallization Temperature (T_{C2})]

The melt crystallization temperature (T_{C2}) of the PGA contained in the PGA particles according to the present invention is 130 to 195° C., preferably 133 to 193° C., more preferably 135 to 192° C., particularly preferably 138 to 190° C. The melt crystallization temperature of the PGA means an exothermic peak appearing in the course of cooling the PGA when a differential scanning calorimeter (DSC) is used to heat the PGA from room temperature to 255° C. at a heating rate of 10° C./min, and then cool it to room temperature at a rate of 5° C./min. If the melt crystallization temperature (T_{C2}) is too high, crystallization prematurely starts in the cooling step in the production process of the PGA particles according to the present invention, which will be described in detail subsequently, and so the control of the particle diameter, particle diameter distribution and particle shape becomes infeasible. If the melt crystallization temperature (T_{C2}) is too low, coarse PGA particles may be formed in some cases. The melt crystallization temperature (T_{C2}) can be controlled by suitably selecting the molecular weight of the PGA and the kind and amount of the polymerization component.

### 3. Polyglycolic Acid Particles

The PGA particles according to the present invention are PGA particles having (i) an average particle diameter of 3 to 50 μm as represented by a 50% cumulative value (D₅₀) in a number particle diameter distribution. Incidentally, the particle diameter of the PGA particles according to the present invention was determined by measuring a particle size distribution by a laser beam diffraction/scattering method.

[Average Particle Diameter (D₅₀)]

The average particle diameter (D₅₀) of the PGA particles according to the present invention means a value represented by the 50% cumulative value (D₅₀) in the number particle diameter distribution, and the value is within a range of 3 to 50 μm, preferably 5 to 48 μm, more preferably 7 to 46 μm, particularly preferably 8 to 44 μm. If the average particle diameter is too small, in some cases, handling property may become poor, or strength may become insufficient. If the average particle diameter is too large on the other hand, resolution is liable to be lowered when the PGA particles are used in, for example, a toner.

### [Particle Diameter Distribution]

The particle diameter distribution according to the present invention is calculated by a ratio of a 90% cumulative value (D₉₀) to a 10% cumulative value (D₁₀) in the number particle diameter distribution, and the value thereof is preferably within a range of 1.1 to 12, more preferably 1.1 to 11, still more preferably 1.1 to 10, particularly preferably 1.1 to 9.5. If the particle diameter distribution is too broad, a scatter of the particle diameter of the PGA particles becomes broad, and in some cases, strength and degradability may become insufficient. In addition, resolution may be liable to be lowered in some cases when used in a toner.

### [Fine Particles Whose Particle Diameter is 1 μm or Smaller]

The PGA particles according to the present invention preferably does substantially not include fine particles whose particle diameter is 1 μm or smaller. The fact that the PGA particles does substantially not include fine particles whose particle diameter is 1 μm or smaller means that a cumulative value of particles having a particle diameter of 1 μm or smaller in the number particle diameter distribution is less than 1.0%. The cumulative value of the particles having a particle diameter of 1 μm or smaller is preferably less than 0.8%, more preferably less than 0.6%, particularly preferably less than 0.4%. If the amount of the fine particles whose particle diameter is 1 μm or smaller is too large, the handling property of such PGA particles is lowered, the strength of resulting coating, toner, etc. becomes insufficient, and the degradation speed of such particles is increased.

### [Porous Particles]

The PGA particles according to the present invention may be provided as porous PGA particles having voids of at least 30%. The porous PGA particle having voids of at least 30% may be used as a biodegradable carrier for coloring matters, perfume bases, agricultural chemicals, medicines, enzymes, physiologically active substances, exothermic substances, endothermic substance, antistatic agents, rust preventives, mildew-proofing agents, deodorants, surfactants, etc., or as a biodegradable adsorbent.

The porous PGA particles according to the present invention are porous particles, in the surfaces of which lots of ruffled pores have been formed, and are observed as an aggregate like a bunch of grapes. The formation of the pores is presumed to be attributable to the fact that when in the production process of the PGA particles, which will be described subsequently, a solution of the PGA dissolved in an aprotic polar organic solvent under heat is cooled to form PGA particles, parts of particles undergo crystal growth while taking the aprotic polar organic solvent in the interior of each particle. When the PGA particles are then separated and washed with an ethanol solution or the like, the aprotic polar organic solvent taken in the interior is dissolved out. As a result, the ruffled pores are formed in the surfaces of the particles. That is, according to the present invention, the porous particles can be efficiently produced with a substantially one kind of solvent.

The voids in the PGA particles according to the present invention are measured in terms of an amount of chlorobenzene adsorbed on 1 g of the PGA particles at ordinary temperature (20° C.) and can be controlled to preferably at least 30%, more preferably at least 40%, still more preferably at least 50%, particularly preferably at least 55%.

In addition, the PGA particles according to the present invention preferably have a specific surface area of 10 to 300 m²/g, more preferably 40 to 290 m²/g, still more preferably 80 to 280 m²/g. Incidentally, the specific surface area of the PGA particles is a value measured according to the BET method by nitrogen adsorption.

In order to obtain the porous PGA particles according to the present invention, it is important to select a proper aprotic polar organic solvent and select and control cooling conditions such as a cooling rate and a stirring state in view of the forming mechanism of the taking-in and dissolving-out of the aprotic polar organic solvent.

### 4. Step (I) (Solution-Forming Step)

The PGA particles according to the present invention can be efficiently produced through Step (I): a solution-forming step of dissolving polyglycolic acid in an aprotic polar organic solvent at a temperature of 150 to 240° C.; Step (II): a cooling step of cooling the solution to obtain a suspension containing PGA particles; and Step (III): a separation step of separating the particles from the suspension.

Step (I) is a solution-forming step of dissolving the PGA in the aprotic polar organic solvent at a temperature of 150 to 240° C. In Step I, PGA adjusted to suitable size and shape by grinding or cutting according to a method known per se in the art is poured into the aprotic polar organic solvent and heated to a temperature of 150 to 240° C. while stirring at a rate within a range of generally 50 to 120 rpm, preferably 60 to 110 rpm, particularly preferably 70 to 100 rpm, and the heated state is kept for a predetermined period of time, thereby dissolving the PGA in the solvent to form a solution of the PGA.

In the present invention, “to form a solution of the PGA” also means a state that most PGA is dissolved in the solvent to form a solution, while a part of the PGA is dispersed in the solution in the form of a melt in addition to case where the PGA is completely dissolved in the solvent to form a solution.

### [Aprotic Polar Organic Solvent]

In the solution-forming step, as the organic solvent dissolving the PGA therein under heat, is used an aprotic polar organic solvent which does not interact with a PGA molecule. An aprotic polar organic solvent is also used as a solvent for depolymerization reaction of the PGA. However, the aprotic polar organic solvent used in this step preferably has a boiling point within a range of 230 to 450° C., more preferably 260 to 430° C., particularly preferably 280 to 420° C. because the PGA is required to be dissolved under heated conditions. If the boiling point of the aprotic polar organic solvent is too low, it is impossible to preset a heating temperature for dissolving the PGA high, so that a dissolution rate of the PGA is lowered, so that it takes a long time for the solution-forming step, or the PGA may not be dissolved in some cases, thereby failing to form a solution. If the boiling point of the aprotic polar organic solvent is too high on the other hand, it may take a long time to remove the solvent in a subsequent step in some cases.

Examples of the aprotic polar organic solvent include aromatic carboxylic acid esters such as dibutyl phthalate, dioctyl phthalate, dibenzyl phthalate, benzyl butyl phthalate and benzyl benzoate; aliphatic carboxylic acid esters such as ethyl acetate, butyl acetate, dimethyl adipate and dimethyl succinate; ether solvents such as ethylene glycol monobutyl ether, dipropylene glycol butyl ether, 2-(2-methoxyethoxy)ethanol (Triglyme), bis(2-methoxyethyl)ether and dibutyl diethylene glycol (DBDG); amide solvents such as dimethylformamide and dimethylacetamide; pyrrolidone solvents such as N-methyl-2-pyrrolidone; and mixtures thereof. However, the solvents are not limited thereto. N-Methyl-2-pyrrolidone (hereinafter may be referred to as “NMP”) is preferred because a suspension containing PGA particles is easily obtained in the cooling step subsequent to the solution-forming step, and the solvent is easily removed from the PGA particles separated in the separation step subsequent thereto.

If such impurities as to have an OH group at a terminal are contained when, for example, an ether solvent is used, there is a possibility that the weight average molecular weight (Mw) of PGA in the resulting PGA particles may be lowered, so that it is important to sufficiently purify the solvent in such a manner that these impurities are reduced to at most 1.0% by mass, preferably at most 0.5% by mass, more preferably at most 0.1% by mass. In addition, in order to control the weight average molecular weight (Mw) of the PGA in the PGA particles, and the average particle diameter and particle diameter distribution of the particles within the predetermined respective ranges, a water content in the aprotic polar organic solvent is preferably low, and so it is better to conduct dehydration according to a method known per se in the art in such a manner the water content is reduced to generally at most 1,200 ppm, preferably at most 1,000 ppm, more preferably at most 700 ppm and at most 400 ppm when particularly wanted.

### [Heating Temperature]

In the solution-forming step of Step (I), the aprotic polar organic solvent is heated to a temperature of 150 to 240° C. to dissolve the PGA in the solvent. The heating temperature of the aprotic polar organic solvent is preferably 160 to 235° C., more preferably 170 to 230° C., particularly preferably 175 to 225° C. If the temperature of the solvent is too low, the PGA is not dissolved, and so the PGA particles according to the present invention cannot be obtained. If the temperature of the solvent is too high, there is a possibility that decomposition of the PGA or solvent may occur to cause color change.

The amount of the PGA poured into the aprotic polar organic solvent is preferably 1 to 30 parts by mass, more preferably 1 to 25 parts by mass, still more preferably 1 to 20 parts by mass per 100 parts by mass of the solvent. If the amount poured is less than 1 part by mass, there is a problem from the viewpoint of productivity. If the amount exceeds 30 parts by mass on the other hand, the PGA may not be dissolved in some cases, and so the PGA particles according to the present invention may not be obtained.

No particular limitation is imposed on a method for heating the aprotic polar organic solvent in the solution-forming step of Step (I). However, a method of heating a reaction vessel, in which the PGA and aprotic polar organic solvent have been placed, by a mantle heater, or the like may be adopted.

### 5. Step (II) (Cooling Step)

Step (II) is a cooling step of cooling the solution of the PGA to 140° C. or lower at a rate less than 20° C./min with stirring to obtain a suspension containing PGA particles.

No particular limitation is imposed on a method for cooling the PGA solution. However, the production process of the PGA particles according to the present invention has a merit in that the solution can be simply cooled by air cooling. For example, a method of allowing a (reaction) vessel, in which the PGA solution has been placed, to cool in an ordinary-temperature atmosphere, what is called spontaneous cooling, may be adopted, or a method of blowing a gas such as air against the vessel by means of a blower or electric fan may also be adopted. The temperature and flow rate of air used for air cooling can be adjusted to control a cooling rate.

In addition, a method of transferring the PGA solution to a cooling container to cool it, a method of cooling the PGA solution by means of a heat exchanger, a method of mixing a solvent cooled to −90 to 20° C. by means of a heat exchanger with the PGA solution to cool the PGA solution may also be adopted. However, it is necessary to control the cooling rate so as to be less than 20° C./min.

The PGA solution obtained in Step (I) and controlled to a temperature of 150 to 240° C. is cooled to 140° C. or lower, preferably 100° C. or lower, more preferably 50° C. or lower, particularly preferably ordinary temperature.

The production process of the PGA particles according to the present invention requires to control the cooling rate in the cooling step to less than 20° C./min, and the cooling rate is preferably 15° C./min or lower, more preferably 12° C./min or lower, particularly preferably 10° C./min or lower. If the cooling rate is 20° C./min or higher, the average particle diameter of the resulting particles becomes less than 3 μm, and a proportion of particles having a particle diameter of 1 μm or smaller increases, and so PGA particles having a narrow particle size distribution may not be obtained in some cases. No particular limitation is imposed on the lower limit of the cooling rate. If the cooling rate is less than 1° C./min, however, it takes a long time for the cooling step, and so there is a possibility that the efficiency of the production process of the PGA particles may become low.

The cooling rate in the cooling step means a maximum value of cooling rates until 140° C. from the beginning of the cooling step. Accordingly, when an average cooling rate in the whole cooling step is controlled by a combination of rapid cooling that a liquid temperature is greatly lowered in a short period of time and slow cooling so as to be less than 20° C./min, the PGA particles according to the present invention may not be obtained in some cases.

The stirring rate of the stirring conducted in the cooling step is generally 30 to 130 rpm, preferably 35 to 120 rpm, more preferably 40 to 110 rpm, and the stirring is conducted at a rate within a range of particularly preferably 45 to 100 rpm, whereby the particle diameter, particle diameter distribution and shape of the resulting PGA particles can be controlled. The cooling rate and stiffing rate are adjusted, whereby porous PGA particles can be obtained.

When the suspension in which the PGA particles are suspended is obtained through the cooling step according to the present invention, there is no need to use a dispersant generally used. However, when a dispersant is used in the cooling step, the suspension can be obtained at a relatively high cooling rate, so that the time required for the cooling step can be shortened. No particular limitation is imposed on the amount of the dispersant used. However, the dispersant may be added in an amount of generally 0.05 to 1.5 parts by mass, preferably 0.1 to 1.0 part by mass, more preferably 0.2 to 0.5 parts by mass per 100 parts by mass of the PGA resin before the cooling step is started or during the cooling step. Examples of usable dispersants include aliphatic alcohols such as decanol and glycerol; aromatic alcohols such as cresol and chlorophenol; and polyalkylene glycol monoethers such as octyl triethylene glycol.

In the cooling step according to the present invention, an operation such as dispersion by ultrasonic waves or dispersion by a stirrer, which is generally adopted upon production of a dispersion liquid of particles, may also be conducted. Examples of a device for the dispersion include a homogenizer, a homomixer, a roll mill, a bead mill and a high-pressure type wet pulverizer. However, when the dispersing operation is conducted in excess, the average particle diameter of the resulting PGA particles may become too small, or the proportion of the fine particles may increase in some cases. Accordingly, attention must be paid.

Further, in the cooling step, for example, an acid catalyst, such as a sulfonic acid such as p-toluenesulfonic acid or dodecylbenznesulfonic acid, or a phosphoric acid such as an alkylphosphoric acid, a curing aid such as an amine-blocked product of the acid catalyst, a leveling agent, an antifoaming agent, an additive such as a lubricant, a colorant such as a pigment, and the like may be added in the cooling step to cause them to be supported on the resulting PGA particles.

A suspension, in which PGA particles having the intended particle diameter and particle diameter distribution have been suspended, is obtained through the cooling step.

### 6. Step (III) (Separation Step)

Step (III) is a separation step of separating the particles from the suspension in which the PGA particles have been suspended. Examples of a method for separating the PGA particles from the suspension include methods such as filtration, in particular, suction filtration, and centrifugal separation. However, the method is not limited thereto. Examples of a filter for filtration include cellulose filter paper and ceramic filters.

In order to make it easy to remove the solvent from the resulting PGA particles, the aprotic polar organic solvent such as NMP contained in the suspension may also be replaced by a higher volatile solvent. Examples of such a solvent include ketones such as methyl ethyl ketone and acetone; alcohols such as methanol and ethanol; hydrocarbons such as hexane, cyclohexane, benzene and toluene; and ethers such as diethyl ether and tetrahydrofuran.

In this separation step, the PGA particles separated are generally washed with an organic solvent. As the organic solvent for washing the PGA particles, may be used acetone or ethanol. In particular, ethanol is preferably used for obtaining porous particles in the surfaces of which lots ruffled pores have been formed.

In the separation step, the PGA particles are preferably dried after the washing is conducted. No particular limitation is imposed on a drying method, and examples thereof include vacuum drying, natural drying and drying by a dryer or oven. However, when the drying is conducted by the dryer or oven, a drying temperature must be preset to a temperature at which the PGA particles are not melted and is within a range of generally 70 to 180° C., preferably 80 to 160° C., more preferably 90 to 140° C. Light aggregates, i.e., granular particles, can also be obtained according to drying conditions.

### 7. Slurry

The PGA particles according to the present invention may be provided as a slurry containing the PGA particles by dispersing them in an organic solvent. The PGA particle-containing slurry may be used for production of a coating and a toner. In addition, the PGA particle-containing slurry may also be used in fields of mining and oil drilling. In particular, the slurry is used as a pressurizing medium easy to be removed by decomposition or particle size change due to pH change.

No particular limitation is imposed on the content of the PGA particles in the slurry, and the content may be suitably adjusted because it varies according to its uses. However, the content is generally 10 to 90% by mass, preferably 15 to 70% by mass, more preferably 20 to 60% by mass.

In the whole resin composition in the slurry, the PGA particles are preferably contained in a proportion of at least 50% by mass, more preferably at least 70% by mass, still more preferably at least 80% by mass. If the amount of the PGA particles added is less than 50% by mass, the effect of the biodegradability cannot be expected, and the intended strength may not be achieved in some cases.

No particular limitation is imposed on proportions of the PGA particles and the organic solvent, and it is only necessary to adjust the proportions according to a desired coating film. However, the proportion of the PGA particles is generally 10 to 40% by mass, preferably 15 to 35% by mass, more preferably 20 to 30% by mass.

In order to produce the PGA particle-containing slurry, a necessary amount of the PGA particles according to the present invention, whose average particle diameter is 3 to 50 μm, preferably 5 to 45 μm, more preferably 7 to 40 μm, are dispersed in a proper organic solvent within a temperature range of the order of ordinary temperature to 80° C. As the organic solvent, may be used an ester solvent such as ethyl acetate or butyl acetate; a dibasic acid ester solvent such as dimethyl adipate or dimethyl succinate; a ketone solvent such as methyl ethyl ketone, cyclohexanone or isophorone; a hydrocarbon solvent such as cyclohexane, toluene or xylene; an alcohol solvent such as benzyl alcohol or cyclohexanol; an ether solvent such as ethylene glycol monobutyl ether, dipropylene glycol butyl ether, 2-(2-methoxyethoxy)ethanol or bis(2-methoxyethyl)ether; an amide solvent such as dimethylformamide or dimethylacetamide; a pyrrolidone solvent such as N-methyl-2-pyrrolidone; or a mixture thereof. Water may also be used as a dispersion medium to provide an aqueous slurry.

Further, an emulsifier may also be incorporated according to a method known per se in the art to use the slurry as an emulsion. In addition, various additives generally publicly known as additives for slurries containing resin particles, for example, a pigment, a viscosity modifier, a leveling agent, an ultraviolet absorber, an antistatic agent, an antioxidant, a weathering agent, a lubricant, an inorganic filler, a fungicide, a mildew-proofing agent and a colorant may be added.

### 8. Coating

As one of uses of the slurry containing the PGA particles according to the present invention, may be mentioned a coating. The coating containing the PGA particles according to the present invention may be coated on ordinary bases to be coated, such as metal plates, metal cans, building materials, resin moldings and formings, rubber moldings and formings, etc., and no particular limitation is imposed on the bases. Further, the coating containing the PGA particles according to the present invention may be used as an (underwater) anti-fouling coating intended to prevent staining by aquatic attached organisms of plants and animals such as microorganisms and algae attached to surfaces of portions sinking in sea or water of various structures such as ships, offshore structures, conduits for hydroelectric power station and irrigation canals, and various tools such as buoys, floats and fishing nets, particularly, as a ship bottom coating.

The coating containing the PGA particles according to the present invention is used by dissolving or dispersing the PGA particles having an average particle diameter within a range of 3 to 50 μm, preferably 5 to 45 μm, more preferably 7 to 40 μm, particularly preferably 8 to 35 μm in the above-described organic solvent or water. An emulsifier may also be incorporated according to a method known per se in the art to provide an emulsion coating. In addition, various additives publicly known as additives for coating, for example, a pigment, a viscosity modifier, a leveling agent, an ultraviolet absorber, an antistatic agent, an antioxidant, a weathering agent, a lubricant, an inorganic filler, a fungicide, a mildew-proofing agent and a colorant may be added.

No particular limitation is imposed on the content of the PGA particles in the coating. However, the content is generally 10 to 90% by mass, preferably 15 to 80% by mass, more preferably 20 to 70% by mass. If the content of the PGA particles in the coating is too low, the biodegradability of a coating film formed becomes insufficient. If the content is too high, the strength of the coating film may become insufficient in some cases.

The amount of the coating applied is controlled to 5 to 5,000 μm in terms of a dry coating thickness according to required performance (period of endurance, etc.), a place applied, etc. The weight of the coating after drying is generally 0.1 to 50 g/m², and the weight is controlled to preferably 1 to 50 g/m², more preferably 3 to 10 g/m². The formation of a coating film is conducted by applying the coating, then evaporating an organic solvent or water by heating if present and then melting the particles. A uniform coating film free of any pinhole is thereby formed to obtain a coating film excellent in solvent resistance or the like. The heating temperature is preferably 100 to 300° C., more preferably 150 to 280° C. The heating time is preferably from 10 seconds to 20 minutes, more preferably from 20 seconds to 10 minutes. Further, water cooling is preferably conducted after the heating. The water cooling is conducted, whereby the appearance and various properties such as processability of the coating film become far excellent.

The coating containing the PGA particles according to the present invention is coated on the base to be coated, thereby obtaining a laminate having at least one layer containing the PGA particles according to the present invention. When the coating film is composed of a plurality of layers, the coating film containing the PGA particles according to the present invention is provided as an outermost layer, whereby biodegradability can be promoted. When such a film is provided as an intermediate layer, the gas barrier properties of the resulting coating film can be improved.

No particular limitation is imposed on a method for applying the coating containing the PGA particles according to the present invention, and the application may be conducted by any of publicly known methods such as, for example, a roll coating method, a spray coating method, a curtain coating method, a brush coating method, a spatula coating method, a dip coating method, an electrodeposition coating method, an electrostatic coating method and an extrusion coating method. The PGA particles according to the present invention may also be used as a powder coating containing the PGA particles without using a solvent to conduct powder coating, thereby forming a coating film.

### 9. Toner

The PGA particles according to the present invention can be utilized for obtaining a toner containing the PGA particles. The PGA particles according to the present invention are used as a toner used in image forming of an electrophotographic system by a copying machine, electrostatic printing, printer, facsimile, electrostatic recording or the like with a colorant, a charge control agent, etc. contained therein if desired, and may be used for making an electric or magnetic latent image visible in image forming apparatus, electrostatic recording apparatus, etc. of the electrophotographic system.

Toner particles heretofore widely used and composed of pulverized particles are produced by uniformly dispersing a colorant, a charge control agent, an offset preventive, etc. in a thermoplastic resin by melting and mixing, and pulverizing and classifying the resulting toner composition. The toner particles composed of the pulverized particles are liable to be formed as particles having a broad particle diameter distribution because brittleness capable of pulverizing is required, and so there has been a problem that a yield becomes low as a result that fine powder and coarse powder are removed by classification. In addition, in the toner particles composed of the pulverized particles, it is difficult to uniformly disperse the colorant, charge control agent, etc. in the resin, so that the resulting toner may have caused adverse influence on flowability, developability, durability, image quality, etc. in some cases.

On the other hand, toner containing the PGA particles according to the present invention can be provided as toner particles having a sharp particle diameter distribution without need of pulverization, so that the above-described various problems can be solved.

No particular limitation is imposed on a process for producing the toner containing the PGA particles according to the present invention. However, examples thereof include a process of coating the surfaces of the PGA particles according to the present invention with additives such as a colorant, a charge control agent and an offset preventive and another resin for forming a surface layer. This coating may also be performed in a vessel containing the PGA particles according to the present invention.

### EXAMPLES

The present invention will hereinafter be described more specifically by Example and Comparative Examples. However, the present invention is not limited to these Examples.

Measuring methods of physical properties and properties of PGAs, coatings, etc. in Examples and Comparative Examples are as follows.

### (1) Weight Average Molecular Weight (Mw), Number Average Molecular Weight (Mn) and Molecular Weight Distribution (Mw/Mn):

The measurements of the weight average molecular weight (Mw) of a PGA, and the weight average molecular weight (Mw), number average molecular weight (Mn) and molecular weight distribution (Mw/Mn) of PGA particles were conducted under the following conditions by means of a gel permeation chromatography (GPC) analyzer.

Sodium trifluoroacetate (product of Kanto Chemical Co., Inc.) is added and dissolved in hexafluoroisopropanol (a product of Central Glass Co., Ltd. was distilled for use) to prepare a 5 mM sodium trifluoroacetate solvent (A).

The solvent (A) is passed through a column (HFIP-LG+HFIP-806M×2; product of SHODEX) at 40° C. and a flow rate of 1 ml/min. Each 10 mg of 5 polymethyl methacrylate reagents (products of POLYMER LABORATORIES Ltd.) respectively having already known molecular weights of 827,000, 101,000, 34,000, 10,000 and 2,000 and the solvent (A) are used to prepare 10 ml of a solution. A 100-μl portion of the solution is passed through the column to determine a detection peak time by detection of refractive index (RI). The detection peak time and molecular weight of each of the 5 standard samples are plotted, thereby preparing a calibration curve for molecular weight.

The solvent (A) is added to 10 mg of the sample to prepare 10 ml of a solution, and a 100-μl portion of this solution is passed through the column to determine a weight average molecular weight (Mw), a number average molecular weight (Mn) and a molecular weight distribution (Mw/Mn) from an elution curve thereof. C-R4AGPC Program Ver 1.2 manufactured by Shimadzu Corporation was used for calculation.

### (2) Terminal Carboxyl Group Concentration

The measurement of a terminal carboxyl group concentration of polyglycolic acid which becomes a raw material of PGA particles was conducted by heating about 300 mg of the PGA for 3 minutes at 150° C. to completely dissolve the polymer in 10 ml of dimethyl sulfoxide, cooling the solution to room temperature, adding 2 drops of an indicator (0.1% by mass Bromothymol Blue/alcohol solution), and then adding a 0.02N sodium hydroxide/benzyl alcohol solution to regard a point that the color of the solution was visually changed from yellow to green as an end point. A terminal carboxyl group concentration was calculated out as an equivalent per ton (10⁶ g) of the polyglycolic acid from the amount added dropwise at that time.

### (3) Content of Residual Glycolide

The measurement of a content of residual glycolide in polyglycolic acid which becomes a raw material of PGA particles was conducted by adding 2 g of dimethyl sulfoxide containing an internal standard substance, 4-chlorobenzophenone, at a concentration of 0.2 g/l to about 100 mg of the PGA, heating the resultant mixture for about 5 minutes at 150° C. to dissolve the polymer, cooling the solution to room temperature, and then conducting filtration. Then, 1 μL of the solution was taken out and poured into a gas chromatograph (GC) to conduct measurement. The content of glycolide was calculated out as % by mass contained in the polyglycolic acid from a numeral value obtained by this measurement. Conditions of the GC analysis are as follows.

Apparatus: “GC-2010” manufactured by Shimadzu Corporation.
Column: TC-17 (0.25 mm in diameter×30 m).
Column temperature: After retained for 5 minutes at 150° C., raising the temperature to 270° C. at a rate of 20° C./min and holding for 3 minutes at 270° C.
Temperature of vaporizing chamber: 180° C.
Detector: FID (hydrogen flame ionization detector), temperature: 300° C.

### (4) 1%-Weight Loss-Starting Temperature on Heating

The measurement of a 1%-weight loss-starting temperature on heating of polyglycolic acid which becomes a raw material of PGA particles was conducted by using a thermogravimetric analyzer TG50 manufactured by METTLER Co., and causing nitrogen to flow at a flow rate of 10 ml/min to heat the PGA at a heating rate of 2° C./min from 50° C. under this nitrogen atmosphere, thereby determining a rate of weight loss. A temperature at which the weight of the polyglycolic acid has been reduced by 1% based on its weight (W50) at 50° C. is precisely read out, and that temperature is regarded as a 1%-weight loss-starting temperature on heating.

### (5) Melting Point (Tm) and Melt Crystallization Temperature (T_{C2})

The measurement of a melting point (Tm) and a melt crystallization temperature (T_{C2}) of polyglycolic acid contained in PGA particles was conducted by detecting an endothermic peak (melting point) appearing in the course of heating and an exothermic peak (melt crystallization temperature) appearing in the course of cooling when a differential scanning calorimeter (DSC) manufactured by Shimadzu Corporation was used to precisely weigh about 10 g of a PGA particle sample, heat the sample from room temperature to 255° C. at a rate of 10° C./min and then cool the sample to room temperature at a rate of 5° C./min

### (6) Average Particle Diameter, Particle Diameter Distribution and Amount of Fine Particles Whose Particle Diameter is 1 μm or Smaller

The average particle diameter and particle diameter distribution of PGA particles, and the amount of fine particles whose particle diameter is 1 μm or smaller were measured by dispersing PGA particles in a 50% by mass aqueous solution of ethanol and subjecting the resultant dispersion to a laser diffraction/scanning method making use of MICROTRAC FRA particle size analyzer manufactured by Nikkiso Co., Ltd.

### (7) Voids

The voids of PGA particles were measured in terms of an amount of chlorobenzene adsorbed on 1 g of the PGA particles at ordinary temperature (20° C.).

### (8) Specific Surface Area

The specific surface area of PGA particles was measured according to the BET method by nitrogen adsorption.

### [Referential Example] Synthesis of PGA

### [Synthesis of Glycolide]

A jacketed stirring vessel was charged with an aqueous glycolic acid solution having a concentration of 70% by mass, and the liquid in the vessel was heated to 200° C. to conduct a condensation reaction while distilling off water outside the system. Low-boiling substances such as water formed and an unreacted raw material were then distilled off while step-wise reducing the pressures of the system, thereby obtaining a glycolic acid oligomer.

The glycolic acid oligomer prepared above was charged into a reaction vessel, diethylene glycol dibutyl ether was added as a solvent, and octyl tetraethylene glycol was further added as a solubilizing agent. A depolymerization reaction was conducted under heating and reduced pressure to distill off glycolide formed together with the solvent. The distillates were condensed by a double-pipe condenser through which hot water was circulated and received in a receiver. The condensate in the receiver was separated into 2 liquids the upper layer of which was a solvent layer, and the lower layer of which was a glycolide layer. Liquid glycolide was taken out from a bottom portion of the receiver, and the resultant glycolide was purified by means of a tower type purifier. The purified glycolide collected was found to have a purity of at least 99.99% as measured by DSC.

### [Polymerization]

Into a closable vessel having a jacket structure and a capacity of 56 l, were added 22.5 kg of the above-described glycolide, 0.68 g (30 ppm) of tin dichloride dihydrate and 1.49 g of water, and an overall proton concentration was controlled to 0.13% by mol. The vessel was closed, steam was circulated through a jacket with stirring, and the contents were heated to 100° C. and melted to provide a uniform liquid. While retaining the temperature of the contents at 100° C., the contents were transferred to a device composed of a tube made of a metal (SUS304) and having an inside diameter of 24 mm. A heating medium oil of 170° C. was circulated, and the contents were held for 7 hours to conduct polymerization. After the polymerization device was cooled by cooling the heating medium oil circulated through the jacket, massive lumps of PGA formed were taken out. A yield was almost 100%. The massive lumps were ground by a grinder. The weight average molecular weight (Mw), terminal carboxyl group concentration, residual glycolide content and 1%-weight loss-starting temperature on heating of the resultant PGA were 200,000, 37 eq/10⁶ g, 0.07% by mass and 217° C., respectively.

### Production of PGA Particles

### Example 1

A separable flask equipped with a thermometer and a polytetrafluoroethylene-made stirring blade (semicircular form having a blade width of 75 mm, a height of 20 mm and a thickness of 4 mm) and having a capacity of 500 ml was charged with 30 g of the PGA prepared in Referential Example and 270 g of NMP (water content: 550 ppm) as a solvent with them precisely weighed. Thereafter, the temperature was set to 210° C. by a mantle heater while causing nitrogen to flow to conduct heating and stirring. A stirring rate was controlled to 80 rpm. After the liquid temperature reached 210° C., stirring was continued for additionally 10 minutes to dissolve the PGA in NMP to form a solution of the PGA. The resultant PGA solution was transparent and light brown.

After it was visually confirmed that the PGA was completely dissolved, cooling was started at a cooling rate of 2.0° C./min by air cooling while holding the mantle heater. A stirring rate was set to 50 rpm. After about 30 minutes, the temperature of the solution was reduced to about 150° C., and it was observed that the deposition of PGA particles was started. The cooling by the air cooling was continued at the same cooling rate, and a suspension, in which the PGA particles were suspended, was subjected to suction filtration by means of cellulose filter paper at the time the temperature of the solution (suspension) reached ordinary temperature, thereby separating the PGA particles. To the PGA particles separated, was added 100 g of acetone, the resultant mixture was stirred and washed for 30 minutes, the washing liquid was then subjected to suction filtration to separate PGA particles. No PGA particle was observed in a filtrate. The PGA particles were then dried for 12 hours in a vacuum dryer set to a temperature of 40° C. Physical property values of the resultant PGA particles were measured, and measured results are shown in Table 1.

### Example 2

PGA particles were obtained in the same manner as in Example 1 except that cooling was conducted at a cooling rate of 10.0° C./min by means of an electric fan in place of the cooling at the cooling rate of 2.0° C./min by air cooling. Physical property values of the PGA particles were measured, and measured results are shown in Table 1.

### Example 3

PGA particles were obtained in the same manner as in Example 1 except that cooling was conducted at a cooling rate of 15.0° C./min by means of an electric fan in place of the cooling at the cooling rate of 2.0° C./min by air cooling. Physical property values of the PGA particles were measured, and measured results are shown in Table 1.

### Example 4

PGA particles were obtained in the same manner as in Example 1 except that 15 g of the PGA and 285 g of NMP were weighed out and added to the separable flask. Physical property values of the PGA particles were measured, and measured results are shown in Table 1.

### Example 5

Porous PGA particles having voids of 53% were obtained in the same manner as in Example 1 except that 15 g of the PGA and 285 g of NMP were weighed out and added to the separable flask, the heating and dissolving temperature in the solution-forming step was changed from 210° C. to 205° C., the cooling rate was changed from 2.0° C./min to 18.0° C./min, 100 g of ethanol was added to the PGA particles separated, and the stirring rate in the cooling step was set to 90 rpm. Physical property values of the PGA particles were measured, and measured results are shown in Table 1.

### Comparative Example 1

After it was visually confirmed that the PGA was completely dissolved in Example 1, the separable flask, in which the PGA solution had been placed, was removed from the mantle heater, and the PGA solution was poured into 700 g of NMP refrigerated to about −30° C. by dry ice without stopping to conduct rapid cooling. As a result, the temperature of the NMP, into which the PGA solution had been poured, was about 85° C. after about 2 seconds (a cooling rate during this is about 3,750° C./min). This NMP, into which the PGA solution had been poured, was left at rest for 2 hours in a refrigerator controlled to 5° C. As a result, PGA particles were precipitated. Hereinafter, the same process as in Example 1 was conducted to obtain PGA particles. Physical property values of the resultant PGA particles were measured, and measured results are shown in Table 1.

### Comparative Example 2

PGA particles were obtained in the same manner as in Example 1 except that after it was visually confirmed that the PGA was completely dissolved in Example 1, the separable flask, in which the PGA solution had been placed, was removed from the mantle heater, and cold air controlled to a temperature of 15° C. was blown against the PGA solution to conduct cooling at a cooling rate of 25.0° C./min Physical property values of the PGA particles were measured, and measured results are shown in Table 1.

### Comparative Example 3

A separable flask having a capacity of 500 ml was charged with 100.0 g of the PGA, 60.0 g of octyl tetraethylene glycol (OTeG) and 100.0 g of dibutyl diethylene glycol (DBDG), and the temperature of a mantle heater was set to 230° C. to conduct heating and stirring. When the temperature of the raw materials charged reached about 200° C., the whole was melted to create a transparent and light brown phase-separation state. After the temperature of the melt reached 230° C., the stirring was continued for additionally 60 minutes to cause the reaction to proceed. As a result, the melt became a dark brown and uniform state. Cooling was then started at a cooling rate of 2.0° C./min by air cooling while holding the mantle heater. Hereinafter, the same process as in Example 1 was conducted to obtain PGA particles. Physical property values of the resultant PGA particles were measured, and measured results are shown in Table 1.

TABLE 1

| | | | | | | | Comp. | Comp. | |
|---|---|---|---|---|---|---|---|---|---|
| | | Ex. 1 | Ex. 2 | Ex. 3 | Ex. 4 | Ex. 5 | Ex. 1 | Ex. 2 | Comp. Ex. 3 |
| Raw PGA | Mw | 200,000 | 200,000 | 200,000 | 200,000 | 200,000 | 200,000 | 200,000 | 200,000 |
| | Mass (g) | 30.0 | 30.0 | 30.0 | 15.0 | 15.0 | 30.0 | 30.0 | 100.0 |
| Solvent | Kind | NMP | NMP | NMP | NMP | NMP | NMP | NMP | OTeG-DBDG |
| | Mass (g) | 270.0 | 270.0 | 270.0 | 285.0 | 285.0 | 270.0 | 270.0 | 160.0 |
| Concentration of | (% by mass) | 10.0 | 10.0 | 10.0 | 5.0 | 5.0 | 10.0 | 10.0 | 38.5 |
| PGA | | | | | | | | | |
| Cooling rate | (° C./min) | 2.0 | 10.0 | 15.0 | 2.0 | 18.0 | 3,750.0 | 25.0 | 2.0 |
| PGA particles | Mw | 55,000 | 73,000 | 79,000 | 77,000 | 80,500 | 63,000 | 88,000 | 29,000 |
| | Mn | 32,000 | 37,000 | 37,800 | 27,000 | 39,000 | 38,000 | 38,300 | 21,000 |
| | Mw/Mn | 1.72 | 1.97 | 2.09 | 2.85 | 2.06 | 1.66 | 2.30 | 1.38 |
| | Melting point (° C.) | 222 | 222 | 223 | 221 | 223 | 222 | 223 | 216 |
| | T_{C2} (° C.) | 150 | 142 | 140 | 140 | 151 | 198 | 138 | 195 |
| | D₁₀ (μm) | 28.60 | 24.20 | 25.00 | 2.60 | 31.20 | 0.95 | 1.07 | 2.40 |
| | D₅₀ (μm) | 47.40 | 33.00 | 34.30 | 8.20 | 42.60 | 1.50 | 2.95 | 9.70 |
| | D₉₀ (μm) | 52.60 | 43.00 | 44.71 | 12.50 | 71.10 | 9.16 | 10.55 | 63.00 |
| | D₉₀/ D₁₀ | 1.84 | 1.78 | 1.79 | 4.81 | 2.28 | 9.64 | 9.86 | 26.25 |
| | 1 μm or smaller | 0.40 | 0.20 | 0.20 | 0.10 | 0.10 | 12.10 | 9.60 | 1.30 |
| | Voids (%) | — | — | — | — | 53 | — | — | — |
| | Specific surface | — | — | — | — | 150 | — | — | — |
| | area (m²/g) | | | | | | | | |

As apparent from the results shown in Table 1, it is understood that in Examples 1 to 5, in which the cooling step of Step (II) was performed at a cooling rate less than 20° C./min near to spontaneous cooling, PGA particles or porous PGA particles having the intended particle diameter, whose average particle diameter D₅₀ fell within a range of 3 to 50 μm while retaining a weight average molecular weight (Mw) as high as at least 30,000, specifically at least 55,000, were obtained.

These PGA particles according to the present invention are particles suitable for use in a slurry used in coatings, toners, oil drilling, etc., and the porous PGA particles may be used as a biodegradable adsorbent, etc.

On the other hand, in Comparative Examples 1 and 2, in which the solution-forming step and the cooling step were performed like Examples, Comparative Example 1, in which the initial cooling rate in the cooling step was about 3,750° C./min,

provided PGA particles which had an average particle diameter D₅₀ as fine as 1.5 μm and was broad in a scatter of particle diameter. In addition, Comparative Example 2, in which the cooling rate in the cooling step was 25.0° C./min, involved a problem that the average particle diameter D₅₀ is as fine as 2.95 μm, and fine particles of 1 μm or smaller are liable to be formed.

In Comparative Example 3, in which the solution-forming step in the production process of the PGA particles according to the present invention was not provided, and particles were produced from the melt of the PGA and the organic solvents, depolymerization of the PGA was caused to proceed. As a result, PGA particles in which the weight average molecular weight (Mw) of PGA was as low as 29,000, and which had the particle diameter distribution D₉₀/D₁₀ of 26.25, and so was broad in a scatter of particle diameter, were obtained. Such particles were insufficient in strength and not fit for use.

### INDUSTRIAL APPLICABILITY

According to the present invention, the PGA particles comprise PGA having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and have (i) an average particle diameter of 3 to 50 μm as represented by a 50% cumulative value (D₅₀) in a number particle diameter distribution, and preferably have (ii) a ratio of a 90% cumulative value (D₉₀) in the number particle diameter distribution to a 10% cumulative value (D₁₀) in the number particle diameter distribution of the particles of 1.1 to 12, whereby the PGA particles can be usefully utilized as a raw material, an additive or the like in industrial fields such as coatings, coating materials, inks, toners, agricultural chemicals, medicines, cosmetics, mining and oil drilling making good use of the properties of the PGA, such as degradability and strength. According to the production process of the PGA particles of the present invention, the PGA particles can be efficiently produced.

1. Polyglycolic acid particles comprising polyglycolic acid having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and having (i) an average particle diameter of 3 to 50 μm as represented by a 50% cumulative value (D₅₀) in a number particle diameter distribution.

2. The polyglycolic acid particles according to claim 1, wherein (ii) a ratio of a 90% cumulative value (D₉₀) in the number particle diameter distribution to a 10% cumulative value (D₁₀) in the number particle diameter distribution is 1.1 to 12.

3. The polyglycolic acid particles according to claim 1, wherein the polyglycolic acid having the above-described (a) to (e) is polyglycolic acid obtained by subjecting 70 to 100% by mass of glycolide and 30 to 0% by mass of another cyclic monomer to ring-opening polymerization.

4. The polyglycolic acid particles according to claim 1, wherein the polyglycolic acid particles are porous polyglycolic acid particles having voids of at least 30%.

5. A production process of polyglycolic acid particles, comprising the following steps (I) to (III):
Step (I): a solution-forming step of dissolving polyglycolic acid in an aprotic polar organic solvent at a temperature of 150 to 240° C.;
Step (II): a cooling step of cooling the solution to 140° C. or lower at a rate less than 20° C./min with stifling to obtain a suspension containing polyglycolic acid particles; and
Step (III): a separation step of separating the particles from the suspension, wherein the polyglycolic acid particles comprise polyglycolic acid having (a) at least 70% by mol of a glycolic acid repeating unit represented by —(O.CH₂.CO)—, (b) a weight average molecular weight (Mw) of 30,000 to 800,000, (c) a molecular weight distribution of 1.5 to 4.0 as represented by a ratio (Mw/Mn) of the weight average molecular weight (Mw) to a number average molecular weight (Mn), (d) a melting point (Tm) of 197 to 245° C. and (e) a melt crystallization temperature (T_{C2}) of 130 to 195° C., and have (i) an average particle diameter of 3 to 50 μm as represented by a 50% cumulative value (D₅₀) in a number particle diameter distribution.

6. The production process of the polyglycolic acid particles according to claim 5, wherein the polyglycolic acid particles have (ii) a ratio of a 90% cumulative value (D₉₀) in the number particle diameter distribution to a 10% cumulative value (D₁₀) in the number particle diameter distribution of 1.1 to 12.

7. The production process of the polyglycolic acid particles according to claim 5, wherein the polyglycolic acid having the above-described (a) to (e) is polyglycolic acid obtained by subjecting 70 to 100% by mass of glycolide and 30 to 0% by mass of another cyclic monomer to ring-opening polymerization.

8. The production process of the polyglycolic acid particles according to claim 5, wherein the polyglycolic acid particles are porous polyglycolic acid particles having voids of at least 30%.

9. The production process of the polyglycolic acid particles according to claim 5, wherein in Step (I), 1 to 30 parts by mass of the polyglycolic acid is dissolved in 100 parts by mass of the aprotic polar organic solvent.

10. A slurry comprising the polyglycolic acid particles according to claim 1.

11. A coating comprising the polyglycolic acid particles according to claim 1.

12. A powder coating comprising the polyglycolic acid particles according to claim 1.

13. A toner comprising the polyglycolic acid particles according to claim 1.
